(19) United States
(12) Patent Application Publication
(10) Pub. No.: US 2025/0225256 A1
(43) Pub. Date: Jul. 10, 2025

(54) Concept for Generating a Cryptographic Address of a Field of an Object

(71) Applicant: Intel Corporation, Santa Clara, CA (US)

(72) Inventors: Michael LEMAY, Hillsboro, OR (US); David M. DURHAM, Beaverton, OR (US); Hans LILJESTRAND, Helsinki (FI)

(21) Appl. No.: 18/619,267

(22) Filed: Mar. 28, 2024

Related U.S. Application Data
(60) Provisional application No. 63/579,528, filed on Aug. 30, 2023.

(51) Int. Cl. G06F 21/60; H04L 9/06

(52) U.S. Cl. CPC G06F 21/602; H04L 9/0643

(57) ABSTRACT

Some aspects of the present disclosure relate to an apparatus comprising memory circuitry, machine-readable instructions, and processor circuitry to execute the machine-readable instructions to obtain a hash value being indicative of an object path of an object, determine specialization information being indicative of a location of a field of the object relative to the object, combine the hash value and the specialization information, and generate a cryptographic address of the field of the object, with the cryptographic address comprising the combination.

This invention was made with Government support under Agreement No. N66001-23-9-4004, awarded by Naval Information Warfare Center Pacific and funded by the Defense Advanced Research Project Agency. The Government has certain rights in the invention.

### TECHNICAL FIELD

The disclosure relates to the improvement of memory safety.

### BACKGROUND

Allocation-based memory protection can be achieved using various means, but intra-object memory protection (e.g., preventing buffer overflows between different fields within the same object) remains an elusive target. Various memory safety mechanisms may be unable to mitigate overflows between different fields within the same structure, known as “intra-object overflows”. Overflows between multiple entries in an array are also instances of this type of issue. In addition, data types may extend beyond their bounds, for example, when a byte type field of an object is type cast to an integer type, a load or store operation will end up writing 32 bits or 64 bits to the a field intended to be of 8 bits in size, potentially accessing other adjacent fields in the object.

“Buf2Ptr” approaches split objects such that each field becomes a distinct allocation. This permits the application of inter-object memory safety controls to isolate what were previously fields within a combined object. Buf2Ptr approaches impose incompatibilities on code. However, this approach drastically changes the memory layout of a program, and in cases such as argument passing, also breaks the ABI by necessitating the use of multiple field-specific pointers to refer to a previously joint compound structure. This may also cause performance issues by necessitating multiple allocation calls and possibly introducing memory fragmentation and register pressure. For example, attempting to pass a pointer to an entire object into some function would not be supported, since the object would have been fragmented into multiple pieces. Invoking the allocator multiple times to generate smaller objects than the original object also introduces additional overheads from the additional execution time in the allocator as well as the additional per-allocation metadata that is needed. Per-allocation padding overheads may also be relatively higher compared to a single padding instance and with less ability to amortize the padding compared to the allocation size.

Capability architectures such as CHERI (Capability Hardware Enhanced Reduced Instruction Set Computer Instructions) encapsulate data types in extended and tagged pointers called capabilities. CHERI doubles the sizes of pointers, which imposes substantial storage overheads and has extensive hardware and software touchpoints for processing the capabilities.

### BRIEF DESCRIPTION OF THE FIGURES

Some examples of apparatuses and/or methods will be described in the following by way of example only, and with reference to the accompanying figures, in which:

FIG. 1 shows a schematic diagram of an example of a format of a cryptographic address;

FIG. 2 shows a schematic diagram of an example of an object hierarchy;

FIG. 3 shows a schematic diagram of an example of an example flow for updating an object path hash field;

FIG. 4 shows a schematic diagram of an example of a flow illustrating reversibility of a combination including a type identifier;

FIG. 5 shows a schematic diagram of an example of an opaque data flow between different translation units; and

FIG. 6a shows a schematic diagram of an example of an apparatus or device, and of a computer system comprising such an apparatus or device;

FIG. 6b shows a schematic diagram of an example of a method;

FIG. 7 shows a schematic diagram of an example of a format of a cryptographic address;

FIG. 8 shows a flow chart of the generation of a cryptographic address; and

FIG. 9 shows a block diagram of a computing device.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the proposed concept relate to cryptographically binding types and displacements for Cryptographic Capability Computing (C3) intra-object isolation. The proposed concept may provide the ability to pass to subroutines pointers referencing nested objects within complex hierarchies of objects with varying field types.

The proposed concept may address intra-object memory protection by building on Cryptographic Capability Computing (C3) to add support for encoding information about paths through object hierarchies, covering both type and relative location information for each level of the hierarchy, into Cryptographic Addresses (CAs) to which data encryption is bound. This may provide cryptographic isolation between distinct fields within an object. An enhanced compiler may use new instructions at each program location where a structure/class field is accessed or has its address taken to encode type and object path information into the CA.

The proposed concept cryptographically binds pointers to a hash of information about the path from some root pointer to a sub-object within an object hierarchy. That information May represent both the type and relative location of the traversed object at each level of the hierarchy. Deriving a pointer to a sub-object from a pointer to a containing object may involve re-encrypting the pointer to update the hash of information to effectively extend the path that it represents through the object hierarchy.

Memory unsafety accounts for ˜70% of software vulnerabilities reported by software industry analysts, so there may be a pressing need for efficient mitigations. The proposed concept may reduce the performance and memory overheads for enforcing intra-object memory safety, which addresses an important category of memory safety issues, compared to prior approaches.

The proposed concept may be implemented as an architectural extension, which may be specified in the manuals of processors that implement the proposed concept. The proposed concept may be implemented using new instructions to be accessed by software using the proposed concept.

Capability architectures such as CHERI encapsulate data types in extended and tagged pointers called capabilities. C3 encodes version and object size cryptographically using encoded cryptographic addresses (pointer values) and data encryption.

For example, data type information could be encoded in the data type information could be encoded implicitly utilizing existing x86 ISA addressing modes or via explicit instructions that allow software-defined type identifiers. Cryptographically binding pointer and data encryption may be dependent on displacements, e.g., of fields within structures.

The proposed concept may provide an approach that allows passing to subroutines pointers referencing nested objects within complex hierarchies of objects with varying field types. The proposed concept may flexibly allow code to generate a pointer to any nested object and pass that to code that is unaware of the parent object hierarchy containing the nested object. This may be done by re-encrypting Cryptographic Addresses (CAs) in a way that depends on the displacement and type of the object referenced by each CA whenever a pointer to a sub-object (e.g., field) is generated. The displacement and type information for the containing objects do not need to be passed to called functions. Instead, a hash of the displacement and type information all the way from the root pointer for the object hierarchy, e.g., the pointer returned by a call to malloc, to the sub-object referenced by the CA may be directly encoded into the CA.

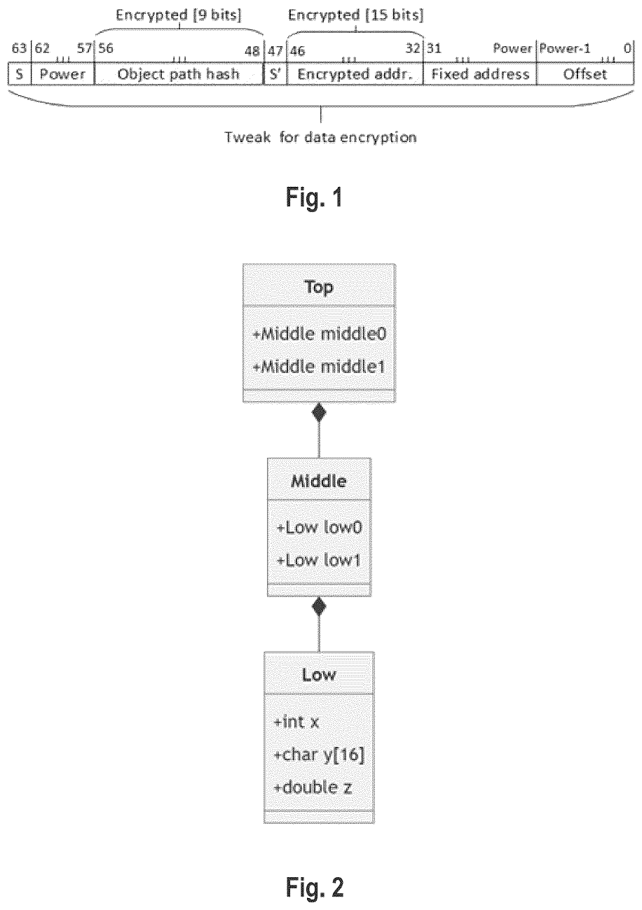

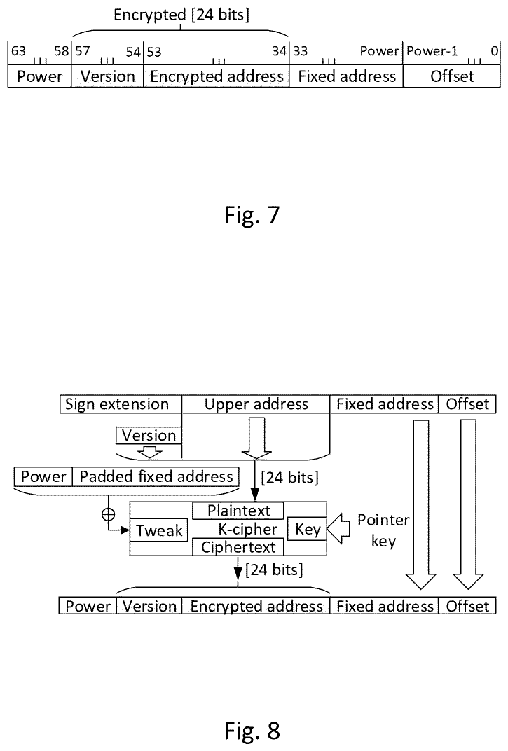

The CA format shown in FIG. 1 may be based on the format shown in FIG. 7 and extended to contain an object path hash.

The allocator for the root object (e.g., the entire top-level object returned by malloc) can initialize the object path hash field to an arbitrary value that varies between different uses of the same underlying linear memory region to effectively version that memory such that stale pointers become unusable for accessing that memory. That version value can be incorporated into subsequent object path hashes.

When a pointer is generated to a field within the top-level object, a new instruction can be used to update the object path hash information. For example, considering the object hierarchy shown in FIG. 2. It may be assumed that the allocator is invoked to reserve space for a single “Top” object, e.g., using a statement such as Top*t=(Top*)malloc(sizeof(Top)). The CA for that object may have its object path hash set to an arbitrary version value that does not encode path information.

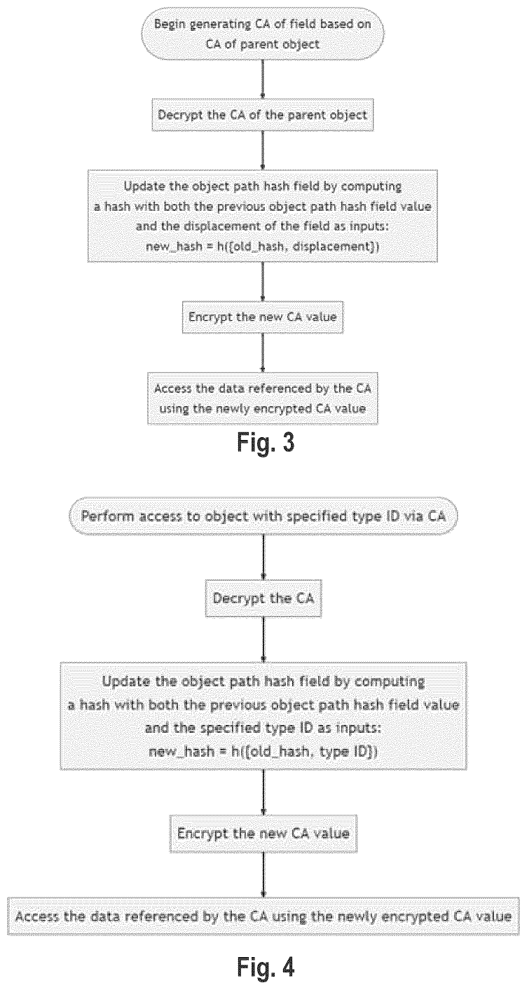

If the code were to subsequently generate a pointer to the middle0 field of *t (*t signifies the object referenced by the CA in variable t), it would re-encrypt the CA and incorporate the displacement of middle0 within *t into the object path hash field. An example flow for how to update the object path hash field in this way is shown in FIG. 3. The method for generating the CA of a field based on a CA of a parent object may comprise decrypting the CA of the parent object. The object path hash field may be updated by computing a hash with both the previous object path hash field value and the displacement of the field as input:
new_hash=h({old_hash, displacement})

Then, the new CA value may be encrypted and the data referenced by the CA may be accessed using the newly encrypted CA value.

This sort of operation of generating a pointer for a particular field within a parent object may be referred to as “specializing” a pointer. A particular instruction for specializing a pointer in this way may be implemented (e.g., by a processor or a middleware/interpreter), e.g., accepting operands for the parent object CA and the displacement, and pointer specialization may also be performed implicitly during memory accesses. Even though the displacement in the third operation may be 0, as when generating a pointer to t->middle0 from t, the new hash value may still differ from the hash value in the pointer to the parent object.

A possible alternative is to specify a sequential field index rather than an address displacement when specializing pointers to fields. This results in a denser encoding, but it requires that the index be specified explicitly, whereas the displacement is already implicitly specified in many instructions.

The properties of the hash function can determine whether it is possible to generate a pointer to a parent object from a pointer to a child object. For example, a one-way hash function would prevent such an operation.

While the object path hash and the encrypted address may be the encrypted part of the CA, the fixed address and the offset may be the not encrypted part of the CA. Additionally, the CA may comprise sign extension bits S, S′.

In some examples, cryptographically binding of type information may be performed. Going beyond location information, it is also possible to encode type information such that each CA is only usable if it is accessed with the correct type information.

Returning to the above example, the top-level object may be considered first. The allocator itself may not have information about the type of the object that it is allocating memory for. Instead, it may only have size information. The returned untyped pointer may then be cast to a specific type by the invoking application (e.g., a structure or array of elements). Thus, extending the compiler to instrument the call to the allocator may be useful, since the compiler is aware of the necessary information about types to be able to encode type information in addition to the version value. Note that this would preclude the allocator from zeroing memory, since the allocator would be unable to generate the CA that will subsequently be used to access the object. Instead, the compiler could insert a call to a zeroing routine after the allocator returns and the correct CA is generated.

The type information may be encoded in the form of a type ID (type identification) that is reversibly combined with the initial object path information value. The type ID may be based on the object primitive type (e.g., char or int), element types or structure of compound types (e.g., of arrays or structs), or other attributes (e.g., whether the pointed-to object/field is a constant). For example, an XOR operation may be used for the combination. The combination may be reversible to be able to enforce that the expected type at the time of access matches the actual type of the object. This may be accomplished by the flow shown in FIG. 4. The method for performing access to an object with specified type ID may comprise decrypting the CA and updating the object path hash field by computing a hash with both the previous object path hash value and the specified type ID as inputs:
new_hash=h({old_hash, type ID})

Then, the new CA value may be encrypted and the data referenced by the CA may be accessed using the newly encrypted CA value.

If the type ID (identifier, e.g., type information) specified at the time of access matches the actual type ID for the object, the third operation in that flow may generate the same object path hash field value for every access to that object, which will result in correct encryption and decryption of the data. Otherwise, there may be a high probability of incorrect encryption or decryption.

A type-based specialization operation may be performed in series with a displacement-based specialization operation, or they may be combined into a single specialization operation by concatenating both the type ID and the displacement when generating the hash function inputs.

The type ID may be determined implicitly based on the type of the instruction used for the memory access, or it may be specified explicitly based on compiler instrumentation.

An explicit specialize pointer instruction may also be used to generate a type-specialized CA.

Even though CAs are stored and propagated in their non-type-specialized form, type specialization may be performed prior to generating a displacement-specialized CA for a field. This allows checking that the correct types are specified at each level of the object hierarchy as it is being used. Otherwise, if type specialization was not performed for each level, only the type of the leaf field being accessed would effectively be checked.

In some examples, bulk memory operations may be adapted to handle objects encrypted using specialized pointers. Not all legitimate memory operations access each location in memory according to its most specific type. For example, memcpy performs bulk copies of arbitrary memory. For correct program functionality, the copied data should be correctly encrypted such that subsequent memory accesses using the most specific types for each field are able to correctly encrypt and decrypt values in memory.

One approach would be to have the compiler 1) instantiate specialized variants of bulk operations that access each field according to its most specific type, and 2) replace each invocation of a generic bulk operation with an invocation of the appropriate specialized variant. This may impose additional code size overhead to store multiple variants of the bulk operations. It may also reduce or eliminate the opportunities to use optimized operations, e.g., SIMD (Single Instruction, Multiple Data) or fast string operation instructions.

A second approach is to avoid binding data cryptography to particular memory locations and to perform bulk operations on the ciphertext domain, e.g., via an ordinary linear address or via a special memory access instruction that simply decrypts a CA to determine the underlying LA (Linear Address) and does not attempt to encrypt or decrypt the data. This may result in identical ciphertext being copied from the source to the destination, and the subsequent data encryption and decryption by normal operations at the destination may then correctly encrypt and decrypt the data.

The sort of function specialization described above need not be limited to just a single function level. Hierarchies of functions, with the top-level function accepting an untyped parameter, may be specialized to particular types recursively. In some cases, this may not be possible, i.e., functions from externally linked binaries, or it may be infeasible due to excessive function specialization leading to code bloat. Consequently, all functions can initially be expected to be non-specialized, such that the compiler can selectively specialize functions and corresponding calls and control-flows. This may also allow the compiler to selectively treat some allocations as monolithic throughout the program, both to maintain binary compatibility with unmodifiable legacy binaries and to avoid excessive or unnecessary specialization. For example, prior to handling a pointer using a specialized type, the compiler may check that the pointer can be traced all the way back to an allocation routine whose result is immediately cast to a specialized type or that it originates from another code sequence that handles it using a specialized type. Other pointers may be handled as referring to monolithic objects.

Some examples may use static analysis to reduce the number of pointer specialization operations. Compiler static analysis may be used for determining what fields within certain object types are always accessed safely and skip generating specialized pointers for those fields to reduce overheads. An even more precise analysis that could further reduce overheads may be to analyze what fields in particular object instances are always accessed safely, but that may require generating duplicates of functions to be applied to different sets of object instances depending on which of the fields are always accessed safely in those various instances. The extra overhead from duplicating functions in that way might outweigh the overhead savings of minimizing the number of pointer specialization operations.

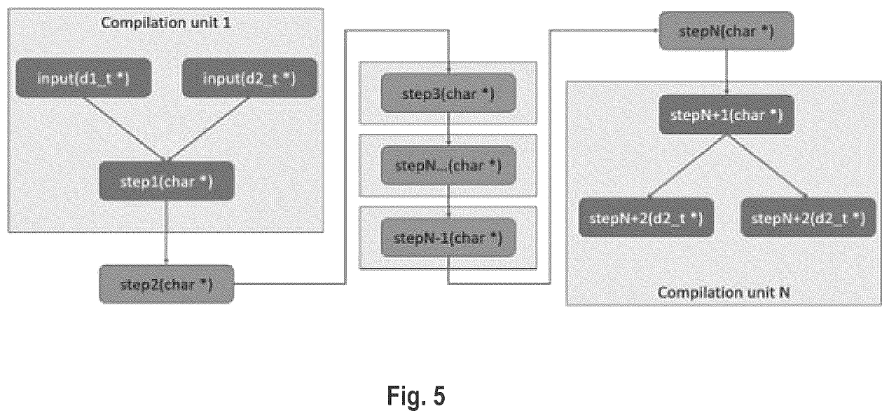

More details and aspects of the concept for cryptographically binding types and displacements for Cryptographic Capability Computing (C3) intra-object isolation are mentioned in connection with the proposed concept or one or more examples described above or below (e.g., FIGS. 5 to 9). The concept for cryptographically binding types and displacements for Cryptographic Capability Computing (C3) intra-object isolation may comprise one or more additional optional features corresponding to one or more aspects of the proposed concept, or one or more examples described above or below.

Various examples of the proposed concept relate to the concept for providing on-demand metadata for intra-object isolation with cryptographic capability computing (C3). The concept for providing on-demand metadata for intra-object isolation with cryptographic capability computing (C3) may extend the concept for cryptographically binding types and displacements for Cryptographic Capability Computing (C3) intra-object isolation, which provides the ability to pass to subroutines pointers referencing nested objects within complex hierarchies of objects with varying field types. The concept for providing on-demand metadata for intra-object isolation with cryptographic capability computing (C3) may extend this approach with opportunistically allocated metadata to support passing such pointers to legacy binaries and un-instrumented code.

As shown in connection with FIGS. 1 to 4, Cryptographic Capability Computing (C3) may be used for intra-object isolation. This approach may be challenging to realize in software systems with complex data dependencies or binary-only components that cannot be instrumented. This section proposes a concept for opportunistically supporting external metadata to enable such protections even for complex software systems that cannot rely on purely static compile-time instrumentation.

This extension may provide support for transparent metadata fetches for intra-object cryptographic isolation in code, legacy binaries or otherwise, that performs bulk operations on opaque memory buffers (e.g., char*) that may contain intra-object isolated data. In contrast to typical metadata approaches, this metadata can be opportunistically created only where static analysis or direct program instrumentation cannot statically instrument the code.

As pointed out in connection with FIGS. 1 to 4, legacy compatibility may hinder the deployment of otherwise are performant solutions. Various examples of the improved concept may improve legacy compatibility of C3 intra-object protection while constraining the performance impact to incompatible code and without affecting C3 performance or security guarantees of otherwise compatible code. This feature may be used in software via new instruction and software constructs specific to specialized CAs. The proposed concept may be provided as an architectural extension, which may be specified manuals of processors that implement this invention.

C3 encodes pointers as cryptographic addresses (CAs) that not only protect the pointer itself from corruption but are also used to encrypt the accessed data to provide cryptographic isolation. FIGS. 1 to 4 show how to provide intra-object isolation generating different CAs for different fields of a compound object such as a C language struct. The intra-object CAs may be generated such that they support nested structures that can be individually addressed, e.g., via pointers to a specific sub-structure of an object. This may be achieved via specialized instructions or implicit memory access behavior orchestrated by the compiler such that it generates a correct CA for sub-field accesses. The version field of the CA (see FIG. 1) may be used as an object path hash, such that a pointer can be further specialized by recalculating the object path hash for a specific field.

The specialized CA may then calculate a new object path hash based on the accessed field. e.g., using the equation hash_{new}=h({hash_{old}, displacement}), where displacement indicates the offset to the accessed field.

This can be efficiently done by software when the type is known. In some cases, the type may not be statically known, or there may be bulk operations that operate at run-time on multiple different compound types with different memory layouts. In some cases, this can be handled by software transformations that convert bulk operations (e.g., memcpy) to individual per-field operations using the corresponding specialized CA. In some cases, opaque pointers (e.g., char*) pointers may be used as generic function arguments to avoid the need for type-specific functions. Such instances may be transformed to use specialized functions that replace such opaque pointers with specific types.

While compile-time analysis and transformation can solve many issues as detailed above, it may require or benefit from full software visibility (e.g., techniques such as link-time optimization) which may be infeasible for complex or legacy systems that may not support link-time optimization or similar techniques. In the worst case, this may preclude specialization of any structures that may be dereferenced outside the current compile-time scope (e.g., compile-time translation unit). For instance, consider FIG. 5 that depicts an opaque data flowing between different translation units (i.e., where the compiler has visibility only to the specific transformed unit, and not the program as a whole). FIG. 5 shows a schematic diagram of a data flow using non-typed opaque pointers across different translation units.

This may force the compiler to conservatively disable intra-object specialization since it cannot verify other translation units can handle such data correctly. In some case this could be avoided by generating function specialization for all possible types, but this is only possible when all types are known across all translation units. Even if it is possible, such extensive function specialization can introduce excessive code bloat and software complexity. Meanwhile, if all run-time memory accesses are performed using the correct type (e.g., after casting back char*pointers to the specific underlying type), then no function specialization is needed. But unless this can be verified at compile-time, function specialization may be needed to guarantee run-time correctness.

Various examples of the proposed concept utilize optional metadata to guarantee binary compatibility between translation units without requiring full system visibility at compile-time. This may be achieved by associating minimal type metadata to any CA that may require specialization and leaves the compile-time visible scope. The type metadata itself can be statically generated and shared between translation units. In most cases, the metadata is not used at run-time, but its existence allows the compiler to assume guaranteed correctness without full visibility, and so, enable intra-object protection on all data. Note that this does not preclude the use of specialized functions or other optimization that can avoid metadata, it merely ensures that the compiler can always, if needed, also generate a general non-typed metadata-based functions, and so, can safely apply intra-object protections on all data.

Since the metadata itself is statically generated, a metadata load might only retrieve a pointer to the static in-memory metadata associated with the CA. The metadata handling may be defined purely in software and improved or optimized to reduce or minimize metadata lookups and code specializations:

```
MD = GetMetadata(CA); // single lookup here
Next_field_offset = GetNextFieldOffset(MD, 0);
for (int i ...) {
  if (i == next_field_offset) {
    new_CA = SpecializeCA(CA+i, MD);
    next_field_offset = GetNextFieldOffset(MD, i);
  }
  ...
}
```

Alternatively, a specialized instruction for CA specialization with an implicit metadata lookup may be used. This instruction may utilize a minimal cache to track next_field_offsets. Such an instruction may simplify code significantly, i.e., code corresponding to the above would be:

```
for (int i ...) {
    new_CA = SpecializeCA(CA+i);
  ...
}
```

In this case the, the SpecializeCA instruction may internally cache the next_field_offset, and MD pointers, such that most iterations simply perform a single compare without updating the pointer. To allow software-defined metadata storage, the SpecializeCA instruction may internally cache a certain number of metadata lookups and trigger metadata lookups via software-defined interrupt handlers. Additionally, there may be an additional instruction that can programmatically configure a metadata association such that the MD pointer can be explicitly passed and configured without any implicit and possibly costly lookup events.

There may be multiple different levels of nesting for a pointer to a specific location (e.g., via nested structs). Consequently, the metadata must be associated with a specific CA, not then underlying memory location. Not all memory locations need to have metadata, and the metadata might be registered only when an opaque pointer leaves the current compile-time scope (e.g., before the call to operation 2 in FIG. 5). The need for metadata may also be indicated in the binaries themselves (e.g., via ABI (Application Binary Interface) versioning or ELF (Executable and Linkable Format) attributes), such that the linker can disable metadata generation when no linked binaries require it.

It is to be noted that most code will not need metadata at all; its main function is to guarantee binary compatibility between different translation units that could otherwise not be guaranteed compatible at compile-time. Without such guarantees, the compiler may conservatively disable intra-object protection for any data that may be affected (e.g., in FIG. 5, this may force the compiler to disable intra-object protection of all pictured).

This approach may further be extended to support binary-compatibility with legacy instructions. In this case a special legacy-mode may be configured in the CPU such that when enabled, any memory operation that encounters a CA may check for metadata and if present, apply the specialization transparently. While such aggressive approaches may incur high performance overhead within the legacy code itself, it avoids the need to dilute the security guarantees due to interactions with external, legacy, or binary-only code.

More details and aspects of the concept for providing on-demand metadata for intra-object isolation with cryptographic capability computing (C3) are mentioned in connection with the proposed concept or one or more examples described above or below (e.g., FIG. 1a to 4, 6a to 9). The concept for providing on-demand metadata for intra-object isolation with cryptographic capability computing (C3) may comprise one or more additional optional features corresponding to one or more aspects of the proposed concept, or one or more examples described above or below.

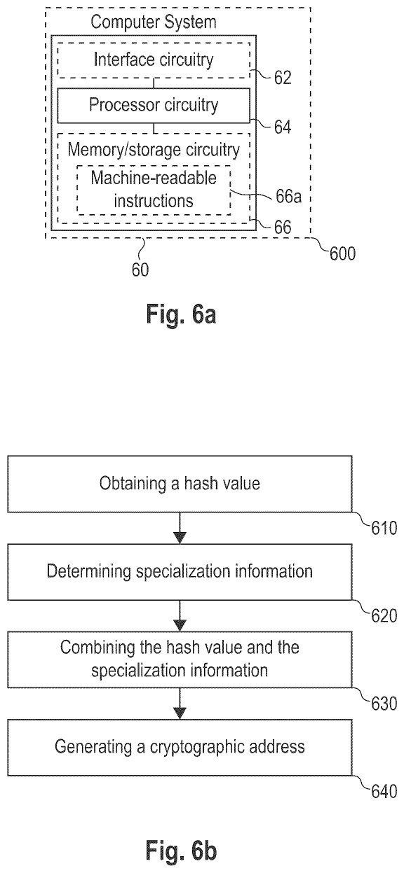

FIG. 6a shows a schematic diagram of an example of an apparatus 60 or device 60, and of a computer system 600 comprising such an apparatus 60 or device 60. The apparatus 60 comprises circuitry to provide the functionality of the apparatus 60. For example, the circuitry of the apparatus 60 may be configured to provide the functionality of the apparatus 60. For example, the apparatus 60 of FIG. 6a comprises (optional) interface circuitry 62, processor circuitry 64, and (optional) memory/storage circuitry 66. For example, the processor circuitry 64 may be coupled with the interface circuitry 62 and/or with the memory/storage circuitry 66. For example, the processor circuitry 64 may provide the functionality of the apparatus, in conjunction with the interface circuitry 62 (for communicating with other entities inside or outside the computing device 600, such as a remote entity), and the memory/storage circuitry 66 (for storing information, such as machine-readable instructions). Likewise, the device 60 may comprise means for providing the functionality of the device 60. For example, the means may be configured to provide the functionality of the device 60. The components of the device 60 are defined as component means, which may correspond to, or implemented by, the respective structural components of the apparatus 60. For example, the device 60 of FIG. 6a comprises means for processing 64, which may correspond to or be implemented by the processor circuitry 64, means for communicating 62, which may correspond to or be implemented by the interface circuitry 62, (optional) means for storing information 66, which may correspond to or be implemented by the memory or storage circuitry 66. In general, the functionality of the processor circuitry 64 or means for processing 64 may be implemented by the processor circuitry 64 or means for processing 64 executing machine-readable instructions. Accordingly, any feature ascribed to the processor circuitry 64 or means for processing 64 may be defined by one or more instructions of a plurality of machine-readable instructions. The apparatus 60 or device 60 may comprise the machine-readable instructions 66a, e.g., within the memory or storage circuitry 66 or means for storing information 66.

The processor circuitry 64 or means for processing 64 is to obtain a hash value being indicative of an object path of an object. The processor circuitry 64 or means for processing 64 is to obtain or determine a specialization information being indicative of a location of a field of the object relative to the object. The processor circuitry 64 or means for processing 64 is to combine the hash value and the specialization information. The processor circuitry 64 or means for processing 64 is to generate a cryptographic address CA of the field of the object, with the cryptographic address comprising the combination.

The hash value may be obtained from a cryptographic address. For example, the hash value may be part of a cryptographic address of the object. For example, a hash value is a unique value or parameter that identifies contents of data that has been secured by cryptography, such that if the contents of the data are modified, the hash value will indicate that the data has been manipulated. In many algorithms, a hash value is generated as a string, which may be fixed-length, of numbers and/or letters generated from a mathematical algorithm and an arbitrarily sized file such as an email, document, picture, or other type of data. This generated string is unique to the file being hashed and is typically a one-way function. For example, a computed hash cannot be reversed to find other files that may generate the same hash value.

The hash value and the specialization information may be combined by calculating a new hash value of the hash value and the specialization information or by another mathematical operation (e.g. multiplication, addition or subtraction). The combination of the hash value and the specialization information may be a hash value itself or another bit string resulting from the calculation.

The CA may comprise the combination (e.g. the new hash value or another bit string resulting from the calculation) as a part of the bit sequence of the CA. The CA may be generated so that the CA comprises a portion being the combination (e.g. the new hash value or another bit string resulting from the calculation) and additional parts.

The CA shown in FIG. 1 may be an example of a generated CA, but also CAs of different length and different order of information may be possible.

For example, the processor circuitry may obtain the hash value being indicative of the object path of the object by decoding a cryptographic address of the object.

In some examples, the specialization information may comprise or may be an address displacement value of the field being indicative of the location of the field of the object relative to the object.

In some examples, the specialization information may comprise or may be a sequential field index being indicative of the location of the field of the object relative to the object.

For example, the combination may comprise a second hash value being indicative of the object path of the object and the location of the field of the object relative to the object.

According to an example, the object path may be a hierarchical object path comprising one or more levels of hierarchy.

In various examples, the processor circuitry may include type information indicating a type of the field in the cryptographic address of the field of the object. The type information or type ID can be any numerical value that represents some type or property the compiler is aware of (e.g., it could be based on structure name, element types, array size, or possibly attributes such as ‘const’). The type information or type ID may be based on the object primitive type (e.g., char or int), element types or structure of compound types (e.g., of arrays or structs), or other attributes (e.g., whether the pointed-to object/field is a constant).

In various examples, the processor circuitry may combine the hash value, the specialization information and the type information, with the cryptographic address of the field of the object comprising the combination. The hash value, the specialization information and the type information may be combined by calculating a new hash value of the hash value, the specialization information and the type information or by another mathematical operation (e.g. multiplication, addition or subtraction).

In various examples, the processor circuitry may generate metadata associated with the cryptographic address, and include at least a subset of the type information in the metadata.

For example, the type information stored in the metadata may be to be retrieved during decryption or specialization of the cryptographic address of the field of the object.

In some examples, the metadata may be linked to the cryptographic address.

In various examples, the type information may be stored in the metadata for binary compatibility with other systems or legacy instructions.

According to an example, generating the cryptographic address may comprise encrypting the combination as part of encrypting the cryptographic address.

According to an example, generating the cryptographic address of the field of the object may be performed at runtime based on the cryptographic address of the object, the cryptographic address of the object comprising the hash value being indicative of an object path of an object.

In various examples, the cryptographic address of the field of the object may be a pointer to the field of the object.

In various examples, the cryptographic address of the field of the object and/or a cryptographic address of the object may be an encrypted memory address.

For example, the cryptographic address of the field of the object and/or a cryptographic address of the object may be an encrypted memory address according to Cryptographic Capability Computing.

An object can be any data that can be stored in memory and manipulated by a program. Examples of objects include, but are not necessarily limited to, data structures, data composites, data elements (e.g., may be within a data structure or data composite), which include any type of primitives or non-primitives. A field of an object may be a part of an object. An object may comprise a plurality of fields.

For example, a hash or hash value is a numeric value of a fixed length that represents a piece of data. The hash value is calculated by a hash function. A hash function may map data of arbitrary size to fixed-size values.

More details and aspects of the apparatus, device, computer system and method are mentioned in connection with the proposed concept, or one or more examples described above (e.g. FIGS. 1 to 5) or below (e.g. FIGS. 6b to 9). The apparatus, device, computer system and method may comprise one or more additional optional features corresponding to one or more aspects of the proposed concept, or one or more examples described above or below.

FIG. 6b shows a flow chart of an example of a corresponding method. The method comprises obtaining 610 a hash value being indicative of an object path of an object. The method comprises determining 620 a specialization information being indicative of a location of a field of the object relative to the object. The method comprises combining 630 the hash value and the specialization information. The method comprises generating 640 a cryptographic address of the field of the object, with the cryptographic address comprising the combination. For example, the method may be performed by the computer system 600, e.g., by the apparatus 60 or device 60 introduced in connection with FIG. 6a.

More details and aspects of the apparatus, device, computer system and method are mentioned in connection with the proposed concept, or one or more examples described above (e.g. FIGS. 1 to 6a) or below (e.g. FIGS. 7 to 9). The apparatus, device, computer system and method may comprise one or more additional optional features corresponding to one or more aspects of the proposed concept, or one or more examples described above or below.

FIG. 7 shows a schematic diagram of an example of a format of a cryptographic address. FIG. 7 shows an example of a 64-bit pointer width, although any pointer size may be supported. Each pointer is divided into distinct fields as illustrated in FIG. 7 to represent a CA in a binary encoding.

The power field specifies the offset field width (e.g. with the value of all zeroes reserved to represent unencoded userspace pointers that point to unencrypted data). Even single-byte slots can be specified, which would impose too much overhead for memory tagging approaches that need to duplicate the tag for every granule (e.g. four tag bits per one-byte data granule would impose 50% memory overhead). Power binds the pointer to an object of a particular memory slot with the corresponding power-of-two size. The object is not required to completely fill the slot, so there is no requirement for padding.

The optional version field can be assigned randomly or in sequence for a given power-of-two slot as the slot is reused to prevent the encrypted data from being bound to the same CA across distinct allocations for temporal safety. Alternatively, the allocator could seek to avoid reusing linear memory with identical radixes while still permitting the memory to be reused and assigned different radixes so that there is no wasted memory. However, that may introduce more allocator complexity. The decrypted version field may be ignored by the processor.

Both the encrypted address bits and the fixed address bits are immutable. If software attempts to change any of them or to forge a pointer, that will be detected with high probability when the corrupted pointer is used in a memory access. A change to an encrypted address bit is likely to change half of the decrypted bits of the decrypted address slice due to the diffusion property of the pointer encryption cipher as will be explained below. This incorrect decryption is likely to point to an unmapped or inaccessible page, generating a page fault, or to some uncontrollable page address. Certain paging modes treat some of the address bits in the encrypted address field as reserved, which causes them to serve as an implicit authentication code by being required to have some predictable value, e.g. all zeroes. C3 may preserve object-granular cryptographic isolation even when pointer corruption or forgery does not generate an exception.

Since the pointer bits are encrypted rather than being authenticated, the values of the underlying pointer bits can be recovered by decrypting the pointer. To detect changes to the fixed address bits, they may be incorporated as a tweak during pointer encryption. For example, an identical tweak is supplied during decryption as was supplied during encryption, or the decryption will be incorrect with a resulting random value with a high probability. The power bits may be incorporated in the tweak to detect unauthorized modifications of those fields. Software may be free to modify the offset bits. Since the supported radixes are all powers of two, the least-significant address digit of the specified radix can be represented as the corresponding number of offset bits.

If there are any allocations that do not fit into a 16 GiB-aligned slot, they can be left unencrypted. In this example, the source of the 16 GiB limit is that the offset field covering the allocation must be kept as plaintext. Thus, 34 plaintext pointer bits can represent at most an 16 GiB-aligned slot. The fixed address bits field will not be present when the pointer refers to a 16 GiB slot, since the entire 34 plaintext bits will be used as the offset.

Furthermore, a special power field value can be designated that represents 16 GiB adjusted slots that are offset by 8 GiB from 16 GiB alignment boundaries, i.e. are shifted by half of their width. This can accommodate allocations spanning 16 GiB alignment boundaries. Although the radix for such adjusted slots would match that for maximally-sized unadjusted slots, those would still effectively reside in separate, isolated cryptographic address spaces.

Unencoded pointers may indicate to the processor that the access should be performed with data encryption and decryption disabled. Unencoded pointers can be detected in constant time, since the equivalent bit locations for the power field will be set to all zeroes or ones for userspace or supervisor pointers, respectively, to match conventional address formats. Those power field values are not used for encoded pointers. Unencrypted accesses can be restricted to particular address ranges, e.g. using page table entry bits.

The pointers may be encrypted using a tweakable block cipher that provides diffusion and confusion and is resistant to known ciphertext attacks. For example, K-cipher may be used. Other ciphers, for example, suitable small block ciphers with the same or different block sizes can be used in place of K-cipher.

An example for generating a CA is illustrated in FIG. 8. It has the following inputs: 1) Plaintext input pointer, 2) Pointer encryption key, and 3) Object context operand specifying the following information: (a) Power indicating the exponent for the power-of-two-aligned slot containing the allocation, and (b) Optional version field.

The pointer encoding algorithm may be implemented by a software routine or as a new instruction. Implementing it as an instruction enables the processor to protect the pointer encryption key by storing it in a register inaccessible from untrusted software (e.g. a write-only MSR) and enables hardware optimization of the pointer encoding algorithm. If implemented as an instruction, the instruction may accept the plaintext input pointer and the object context operand as explicit instruction operands. It may also implicitly load the pointer encryption key from the register that contains it. The operating system OS would initialize the pointer encryption key register with a per-process key analogous to a per-process PAuth key. Other key management mechanisms may be employed to support various threat models.

For example, the tweak input to the pointer encryption comprises all of the plaintext pointer components that need to be protected from being modified by the software. The fixed address bits field from the plaintext input pointer is padded to always have a width of 34 bits and to maintain the relative positions of each bit in the padded field (i.e. padding on the right). An XOR fold operation (or some other more sophisticated approach such as a lightweight permutation) for generating the tweak may be needed due to the input fields being wider (40 bits) than the 24-bit block size of the pointer encryption cipher.

The pointer decode flow may be the reverse of the pointer encode flow with the requirement that the same tweak value be supplied. Decoding may also drop the optional version field, since it does not affect the generated linear address.

For example, each allocation is assigned a distinct Cryptographic Address (CA), which results in every allocation being uniquely encrypted. To understand how every allocation is distinguished spatially from all other simultaneously-valid allocations, it is helpful to think of each CA effectively defining a naturally-aligned power-of-two slot that contains the allocation in its entirety. Allocations do not need to be aligned to a power-of-two, i.e. there is no requirement for an allocation to fill its assigned slot. To ensure that each allocation is assigned to a distinct slot, a “best-fit” criterion could be used to select the smallest slot that completely contains a given allocation, which will have the minimum space in the slot that is outside of the actual allocation. Every allocation may then cross the midpoint of its assigned allocation slot. Only a single allocation can cross any particular slot's midpoint. If the allocation fits within some slot, but it does not cross that slot's midpoint, then it must fit more tightly in some smaller slot, and hence the best-fit algorithm would have selected that smaller slot. Therefore, for a given spatial memory layout, only a single allocation can be assigned to any slot.

The memory layout of allocations is not disrupted. The best-fit power-of-two slot of a particular allocation can overlap with other allocations, as padding is not to fill the slot. Even in this case, the data for the separate allocations remains cryptographically isolated due to the allocations each being assigned unique CAs to which the data encryption is bound. Using a pointer to an allocation in some slot to read or overwrite a different allocation within the bounds of the same slot results in the data for the second allocation being garbled. This preserves the confidentiality of that data and makes data corruption unpredictable to adversaries.

Furthermore, data encryption may be distinctly well-suited to comprehensively mitigating uninitialized use throughout an entire allocation. C3 may break adversaries' control over uninitialized data values by encrypting stale data from previous allocations when read through a fresh CA with a different radix or version. This applies separately to every byte of the allocation, such that even a single remaining uninitialized byte is still mitigated by C3. In contrast, the overheads of per-byte initialization metadata may be prohibitive.

When a C3 pointer is dereferenced that is corrupted, stale, or references an uninitialized allocation, the data will be garbled with high probability if the decrypted pointer even references accessible memory in the first place.

The CA of FIG. 1 may be generated similarly to the CA of FIG. 7. The bits of the object path hash and the encrypted address of the CA of FIG. 1 may be treated in the same or similar way as the version bits and the encrypted address of the CA of FIG. 7.

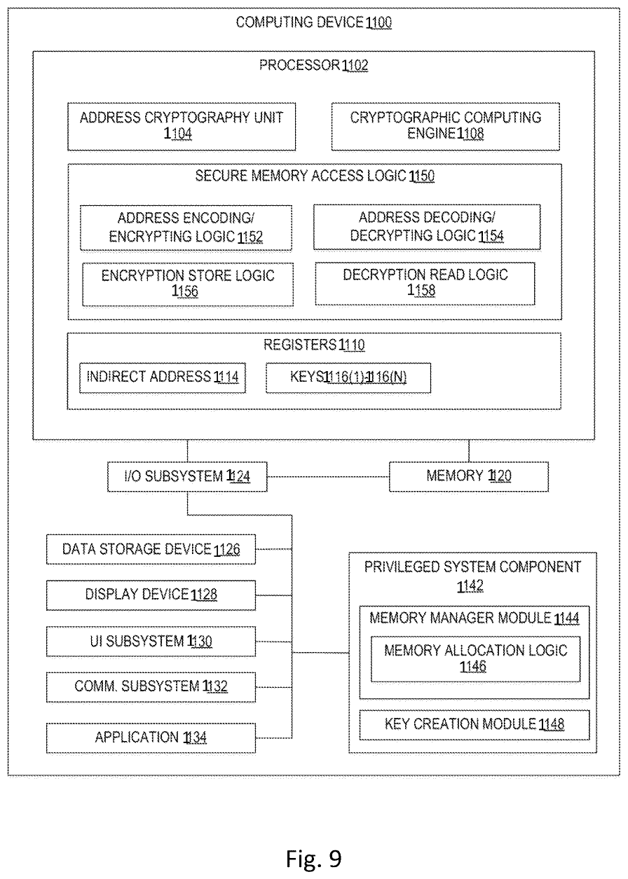

More details and aspects of the apparatus, device, computer system and method are mentioned in connection with the proposed concept, or one or more examples described above (e.g. FIGS. 1 to 6b) or below (e.g. FIG. 9). The apparatus, device, computer system and method may comprise one or more additional optional features corresponding to one or more aspects of the proposed concept, or one or more examples described above or below.

FIG. 9 is a simplified block diagram of an example computing device 1100 configured with secure memory access logic according to at least one example of the present disclosure. In the example shown, the computing device 1100 includes a processor 1102 having a set of secure memory access logic 1150 and a number of registers 1110. The secure memory access logic 1150 utilizes metadata about an indirect address 1114, which is encoded into unused bits of the indirect address 1114 (e.g., non-canonical bits of a 64-bit address, or a range of addresses set aside, e.g., by the operating system, such that the corresponding high order bits of the address range may be used to store the metadata), in order to secure and/or provide access control to memory locations pointed to by the indirect address 1114. For example, the metadata encoding and decoding provided by the secure memory access logic 1150 can prevent the indirect address 1114 from being manipulated to cause a buffer overflow, and/or can prevent program code from accessing memory that it does not have permission to access. Address encoding logic 1152 of the secure memory access logic 1150 is invoked when memory is allocated (e.g., by an operating system, in the heap) or when addresses are specialized to specific object fields and provided to executing programs in any of a number of different ways, including by using a function such as malloc, alloc, or new; or implicitly via the loader, or statically allocating memory by the compiler, etc. As a result, the indirect address 1114, which points to the allocated memory, is encoded with the address metadata comprising in part of the object path hash.

The address metadata may also include valid range metadata. The valid range metadata allows executing programs to manipulate the value of the indirect address 1114 within a valid range, but will corrupt the indirect address 1114 if the memory is accessed using the indirect address 1114 beyond the valid range. Alternatively or in addition, the valid range metadata can be used to identify a valid code range, e.g., a range of memory that program code is permitted to access (e.g. the encoded range information can be used to set explicit ranges on registers). Other information that can be encoded in the address metadata includes access (or permission) restrictions on the indirect address 1114 (e.g., whether the indirect address 1114 can be used to write, execute, or read the referenced memory).

In at least some other examples that will be further described herein, other metadata (or context information) can be encoded in the unused bits of indirect address 1114 such as a size of plaintext address slices (e.g., number of bits in a plaintext slice of a memory address embedded in the indirect address), a memory allocation size (e.g., bytes of allocated memory referenced by the indirect address), a type of the data or code (e.g., class of data or code defined by programming language), permissions (e.g., read, write, and execute permissions of the indirect address), a location of the data or code (e.g., where the data or code is stored), the memory location where the pointer itself is to be stored, an ownership of the data or code, a version of the indirect address (e.g., a sequential number that is incremented each time an indirect address is created for newly allocated memory, determines current ownership of the referenced allocated memory in time), a tag of randomized bits (e.g., generated for association with the indirect address), a privilege level (e.g., user or supervisor), a cryptographic context identifier (or crypto context ID) (e.g., randomized or deterministically unique value for each indirect address), etc. For example, in one example, the address metadata can include size metadata that encodes the size of a plaintext address slice in the indirect address. The size metadata may specify a number of lowest order bits in the indirect address that can be modified by the executing program. The size metadata is dependent on the amount of memory requested by a program. Accordingly, if 16 bytes are requested, then size metadata is encoded as 4 (or 00100 in five upper bits of the pointer) and the 4 lowest bits of the pointer are designated as modifiable bits to allow addressing to the requested 16 bytes of memory. In some examples, the address metadata may include a tag of randomized bits associated with the indirect address to make the tag unpredictable for an adversary. An adversary may try to guess the tag value so that the adversary is able to access the memory referenced by the pointer, and randomizing the tag value may make it less likely that the adversary will successfully guess the value compared to a deterministic approach for generating the tag value. In some examples, the pointer may include a version number (or other deterministically different value) determining current ownership of the referenced allocated data in time instead of or in addition to a randomized tag value. Even if an adversary is able to guess the current tag value or version number for a region of memory, e.g., because the algorithm for generating the version numbers is predictable, the adversary may still be unable to correctly generate the corresponding encrypted portion of the pointer due to the adversary not having access to the key that will later be used to decrypt that portion of the pointer.

Address decoding/decrypting logic 1154 verifies the encoded metadata on memory read and write operations that utilize processor instructions such as MOV, where a general purpose register is used as a memory address to read a value from memory (e.g., load) or to write a value to memory (e.g., store), as well as on other operations that involve the “use” of memory (such as arithmetic instructions with memory operands, e.g. ADD, and control transfer instructions, e.g. CALL/JMP etc.). These are considered memory operands, which may specify a location in memory at which the destination address for the control transfer is stored. The example secure memory access logic 1150 is embodied as part of processor instructions (e.g., as part of the processor instruction set architecture), or microcode (e.g., instructions that are stored in read-only memory and executed directly by the processor 1102). In other examples, portions of the secure memory access logic 1150 may be embodied as hardware, firmware, software, or a combination thereof (e.g., as programming code executed by a privileged system component 1142 of the computing device 1100). For example, the secure memory access logic 1150 may be embodied in software as an instruction set emulator (e.g., a binary instrumentation tool such as a PIN Tool) that emulates the instruction logic utilizing the encoded addresses as disclosed herein.

The secure memory access logic 1150 is executable by the computing device 1100 to provide security for indirect addresses “inline,” e.g., during execution of a program (such as a user space software application) by the computing device 1100. As used herein, the terms “indirect address” and “pointer” may each refer to, among other things, an address (e.g. virtual address or linear address) of a memory location at which other data or instructions are stored. In an example, a register that stores an encoded memory address of a memory location where data or code is stored may act as a pointer. As such, the indirect address 1114 may be embodied as, for example, a data pointer (which refers to a location of data), a code pointer (which refers to a location of executable code), an instruction pointer, or a stack pointer. Indirect addresses may be referred to by other terminology, such as “pointer,” “address pointer,” or “pointer address.” As used herein, “metadata” may refer to, among other things, information about or relating to an indirect address 1114, such as a valid data range, a valid code range, pointer access permissions, a size of plaintext address slice (e.g., encoded as a power in bits), a memory allocation size, a type of the data or code, a location of the data or code, an ownership of the data or code, a version of the indirect address, a tag of randomized bits, version, a privilege level of software, a cryptographic context identifier, etc.

As used herein, “memory load” may refer to, among other things, a “MOV”, “LOAD”, or “POP” instruction or any other instruction that causes data to be read, copied, or otherwise accessed at one storage location, e.g., memory, and moved into another storage location, e.g., registers (where “memory” may refer to main memory or cache, e.g., a form of random access memory, and “register” may refer to a processor register, e.g., hardware), or any instruction that accesses or manipulates memory. Also as used herein, “memory store” may refer to, among other things, a “MOV”, “STORE”, or “PUSH” instruction or any other instruction that causes data to be read, copied, or otherwise accessed at one storage location, e.g., register, and moved into another storage location, e.g., memory, or any instruction that accesses or manipulates memory.

However, the indirect address encoding/decoding technology disclosed herein is not limited to MOV or load/store instructions. For example, control transfer instructions such as call and jump instructions can be adapted to handle encoded indirect addresses in a similar manner as described herein with respect to MOV instructions, wherein code is to execute within a valid address range. Likewise, the instruction pointer (e.g., register) may be range bound given the encoded address specified by the control transfer instruction (e.g. JMP/CALL) results in an encoded address being used for the instruction pointer, thus restricting valid program execution to within a valid address range (effectively, the program counter can increment correctly until it reaches the end of the encoded range). Furthermore, in some architectures, any number of processor instructions may have a memory operand in the form of an indirect address (e.g. arithmetic operations such as ADD, SUB, MUL, AND, OR, XOR, etc. may have a source/destination memory reference in the form of an indirect address and/or a source/destination register operand). In other architectures, however, the format of memory operands may vary. For example, registers may be combined in some way (e.g., by addition) to produce an effective address. Additionally, other parameters may optionally be included, such as a scaling factor that multiplies one of the register values (e.g., the index) and/or a constant displacement value embedded in the instruction that is directly added. Further, it should be noted that while the illustrative examples refer to “instructions,” such instructions may be embodied as, e.g., processor instructions, operating system routines, or other forms of computer program code.

The example secure memory access logic 1150 includes address encoding/encrypting logic 1152 (which can include logic to perform metadata encoding and address encryption), encryption store logic 1156, and decryption read logic 1158. Illustratively, the address decoding/decrypting logic 1154 (which can include logic for decrypting and forming a linear address from an encoded pointer), can be embodied in encryption store logic 1156 and decryption read logic 1158, but may be embodied in other processor instructions, or as a separate instruction or series of instructions, or as higher-level code executed by a privileged system component such as an operating system kernel or virtual machine monitor, or as an instruction set emulator. As described in more detail below, the address encoding logic 1152 and the address decoding/decrypting logic 1154 each operate on an indirect address 1114 using metadata (e.g., one or more of valid range, permission metadata, size (power), memory allocation size, type, location, ownership, version, tag value, privilege level (e.g., user or supervisor), crypto context ID, etc.) and a secret key (e.g., secret key 1116(1)), in order to secure the indirect address 1114 at the memory allocation/access level. Also as described in more detail below, the encryption store logic 1156 and decryption read logic 1158 each operate on data (referenced by indirect address 1114) using at least a portion of the indirect address and a secret key (e.g., secret key 1116(2)), in order to secure the data at the memory location referenced by the indirect address 1114 by binding the data encryption to the indirect address.

The example indirect address 1114 is embodied as a register 1110 (e.g., a general purpose register of the processor 1102). Generally, keys 1116(1)-1116(N) and tweaks 1117 can be handled in any suitable manner based on particular needs and architecture implementations. The keys and tweaks may be stored in registers 1110 or memory 1120.

The example secret keys 1116(1)-1116(N) may be generated by a key creation module 1148 of a privileged system component 1142, and stored in one of the registers 1110 (e.g., a special purpose register or machine specific register (MSR)), or another memory location that is readable by the processor 1102. In some examples, the secret keys 1116(1)-1116(N) may be stored in a location that is readable only by the processor. In other examples, the secret keys 1116(1)-1116(N) used to secure indirect addresses, data, and code can be stored in another memory location, such as in firmware, in a secure portion of the data storage device 1126 or another data storage device, or another form of memory suitable for performing the functions described herein. In some examples, the secret keys 1116(1)-1116(N) may be transmitted across a secure communications channel and restored by an executive (such as an operating system or a virtual machine monitor, e.g., the privileged system component 1142 described below). In virtualized environments in which virtual machines are migrated from one machine to another, and/or in cases in which a virtual machine, process or program running on the computing device 1100 begins a sleeping/hibernating mode after an indirect address and the referenced data and/or code are secured using secret keys, and then later resumes, the secret keys will need to be recovered and restored. In these cases, the secret keys can be stored or possibly transmitted across a (secure) communications channel prior to a sleeping/hibernating mode, and then retrieved/restored by an executive (such as an operating system or a virtual machine monitor, e.g., the privileged system component 1142).

It should be noted that examples described herein allow for any number of secret keys to be used for a particular program. In one example, the same secret key may be used for all indirect addresses used in a program. In another example, a different secret key may be used for each indirect address associated with a different memory allocation or for each predefined group of memory addresses associated with different memory allocations. In yet further examples, the same secret key used for an address encryption/decryption may also be used for encrypting the data bound to that address. In other examples, one secret key may be used for address encryption/decryption, while a different secret key may be used for data encryption/decryption bound to that address. For ease of explanation, examples further described herein refer to “secret address key” or “address key” to refer to the use of a secret key in encryption and decryption operations of memory addresses and “secret data key” or “data key” to refer to the use of a secret key in operations to encrypt and decrypt data.

On (or during) a memory allocation operation (e.g., a “malloc”), memory allocation logic 1146 allocates a range of memory for a buffer and returns the indirect address 1114 and the metadata (e.g., one or more of range, permission metadata, size (power), memory allocation size, type, location, ownership, version, tag, privilege level, crypto context ID, etc.). For example, the memory allocation logic 1146 may encode plaintext range information in the indirect address 1114 (e.g., in the unused/non-canonical bits, prior to encryption), or supply the metadata as one or more separate parameters to the instruction, where the parameter(s) specify the range, code permission information, size (power), memory allocation size, type, location, ownership, version, tag, privilege level (e.g., user or supervisor), crypto context ID, or some suitable combination thereof. Illustratively, the memory allocation logic 1146 is embodied in a memory manager module 1144 of the privileged system component 1142. The memory allocation logic 1146 initiates the address encoding logic 1152. The address encoding logic 1152 includes metadata encoding logic 1156, which encodes the indirect address 1114 with the metadata (e.g., object path hash, range, permission metadata, size (power), memory allocation size, type, location, ownership, version, tag value, privilege level, crypto context ID, some suitable combination thereof, etc.) and potentially an “adjustment,” for example if range metadata is encoded, as described below. The address encoding logic 1152 stores the metadata in an unused portion of the indirect address 1114 (e.g., non-canonical bits of a 64-bit address). For some metadata or combinations of metadata, the indirect address 1114 may be encoded in a larger address space (e.g., 128-bit address, 256-bit address) to accommodate the size of the metadata or combination of metadata.

To determine valid range metadata, example range rule logic selects the valid range metadata to indicate an upper limit for the size of the buffer referenced by the indirect address 1114. Address adjustment logic adjusts the valid range metadata as needed so that the upper address bits (e.g., most significant bits) of the addresses in the address range do not change as long as the indirect address 1114 refers to a memory location that is within the valid range indicated by the range metadata. This enables the indirect address 1114 to be manipulated (e.g., by software performing arithmetic operations, etc.) but only so long as the manipulations do not cause the indirect address 1114 to go outside the valid range (e.g., overflow the buffer).

In an example, address encoding/encrypting logic 1152 uses the valid range metadata to select a portion (or slice) of the indirect address 1114 to be encrypted. In other examples, the slice of the indirect address 1114 to be encrypted may be known a priori (e.g., upper 32 bits, lower 32 bits, etc.). The address encoding/encrypting logic 1152 encrypts the selected slice of the indirect address 1114 (and the adjustment, in some examples), using the secret address key 1116(1) and an address tweak, as described further below. On a memory access operation (e.g., a read, write, or execute operation), the address decoding/decrypting logic 1154 decodes the previously-encoded indirect address 1114. To do this, the address decoding/decrypting logic 1154 decrypts the encrypted slice of the indirect address 1114 (and in some examples, the encrypted adjustment) using the secret key 1116(1) and the address tweak, as described further below.

The indirect address 1114 is returned to its original (e.g., canonical) form, based on appropriate operations in order to restore the original value of the indirect address 1114 (e.g., the true, original linear memory address). To do this in at least one possible example, the address metadata encoded in the unused bits of the indirect address 1114 may be removed, e.g., return the unused bits to their original form). If the indirect address 1114 decodes successfully, the memory access operation completes successfully. However, if the encoded indirect address 1114 has been manipulated (e.g., by software, inadvertently or by an attacker) so that its value falls outside the valid range indicated by the range metadata (e.g., overflows the buffer), the indirect address 1114 will be corrupted as a result of the decrypting process performed by the address decoding/decrypting logic 1154. A corrupted indirect address will raise a fault (e.g., a general protection fault or a Page Fault if the address is not mapped as present from the paging structures/page tables). One condition that may lead to a fault being generated is a sparse address space. In this scenario, a corrupted address is likely to land on an unmapped page and generate a page fault. In this way, the secure memory access logic 1150 enables the computing device 1100 to provide indirect address security against buffer overflow attacks and similar exploits. Examples of the indirect address security technologies disclosed herein can also be used for software debugging purposes or as an access control mechanism to prevent software from accessing areas of memory for which the software does not have permission. Additionally, in comparison to other buffer overflow mitigation techniques, examples of the disclosed indirect address security technologies can operate without any additional memory reads/writes, or without any additional instructions, or without any binary modifications, or without the need to recompile legacy code. Moreover, examples of the disclosed technologies are responsive to adversaries that can read memory and overwrite pointer values, as well as adversaries that can create/select arbitrary pointer values. Further, examples of the disclosed technologies can scale from very small memory ranges to very large memory ranges, or can cascade memory ranges within other memory ranges by using different encoded pointers. Still further, examples of the disclosed technologies are effective with dynamic memory allocation (e.g., due to the ability to programmatically create range encoded pointers inline). Additionally, examples of the disclosed technologies can be extended to provide code block (code location) access controls to data. Further, examples of the disclosed technologies are compatible with 64-bit versions of the x86 instruction set, as well as ARM, MIPS, PowerPC and other processor architectures, including wider (e.g., greater than 64-bit) address bit architectures and smaller (e.g. 32-bit) architectures by reserving address ranges for the metadata containing addresses.

Some examples of the disclosed technologies utilize aspects of address adjustment logic and address restoration logic to support legacy code compatibility, as described below. As used herein, “legacy code” may refer to a version of computer code that was designed to work on an earlier, or now-obsolete, or no-longer-supported computer architecture. For example, legacy code may include software that was originally developed for a 32-bit processor, but which is now running on a 64-bit processor. “Legacy code” also refers to a version of computer code designed without using or being adapted to use dedicated instructions for encoding and encrypting indirect addresses as described herein. At least some examples disclosed herein can be implemented without using new program instructions and accordingly, without the need for recompiling legacy code.

Referring now in more detail to FIG. 9, the computing device 1100 may be embodied as any type of electronic device for performing the functions described herein. For example, the computing device 1100 may be embodied as, without limitation, a smart phone, a tablet computer, a wearable computing device, a laptop computer, a notebook computer, a mobile computing device, a cellular telephone, a handset, a messaging device, a vehicle telematics device, a server computer, a workstation, a distributed computing system, a multiprocessor system, a consumer electronic device, and/or any other computing device configured to perform the functions described herein. As shown in FIG. 1, the example computing device 1100 includes at least one processor 1102 embodied with the secure memory access logic 1150.

The computing device 1100 also includes memory 1122, an input/output subsystem 1124, a data storage device 1126, a display device 1128, a user interface (UI) subsystem 1130, a communication subsystem 1132, at least one user space application 1134, and the privileged system component 1142 (which, illustratively, includes the memory manager module 1144 and the key creation module 1148). The computing device 1100 may include other or additional components, such as those commonly found in a mobile and/or stationary computers (e.g., various sensors and input/output devices), in other examples. Additionally, in some examples, one or more of the example components may be incorporated in, or otherwise form a portion of, another component. Each of the components of the computing device 1100 may be embodied as software, firmware, hardware, or a combination of software and hardware.

The processor 1102 may be embodied as any type of processor capable of performing the functions described herein. For example, the processor 1102 may be embodied as a multi-core processor, other multiple-CPU processor or processing/controlling circuit, or multiple diverse processing units or circuits (e.g., CPU and GPU, etc.). The processor 1102 has a number of registers 1110, which include general purpose registers and special purpose registers. The indirect address 1114 and the secret keys 1116(1)-1116(N) are stored in registers 1110. The memory 1122 of the computing device 1100 may be embodied as any type of volatile or non-volatile memory or data storage capable of performing the functions described herein. In operation, the memory 1122 may store various data and software used during operation of the computing device 1100, as well as operating systems, applications, programs, libraries, and drivers.

The memory 1122 is communicatively coupled to the processor 1102, e.g., via the I/O subsystem 1124. The I/O subsystem 1124 may be embodied as circuitry and/or components to facilitate input/output operations with the processor 1102, the memory 1122, and other components of the computing device 1100. For example, the I/O subsystem 1124 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some examples, the I/O subsystem 1124 may form a portion of a system-on-a-chip (SoC) and be incorporated, along with the processor 1102, the memory 1122, and/or other components of the computing device 1100, on a single integrated circuit chip.

The data storage device 1126 may be embodied as any type of physical device or devices configured for short-term or long-term storage of data such as, for example, memory devices and circuits, memory cards, hard disk drives, solid-state drives, flash memory or other read-only memory, memory devices that are combinations of read-only memory and random access memory, or other data storage devices.

The display device 1128 may be embodied as any type of display capable of displaying digital information such as a liquid crystal display (LCD), a light emitting diode (LED), a plasma display, a cathode ray tube (CRT), or other type of display device. In some examples, the display device 1128 may be coupled to a touch screen or other human computer interface device to allow user interaction with the computing device 1100. The display device 1128 may be part of the user interface (UI) subsystem 1130. The user interface subsystem 1130 may include a number of additional devices to facilitate user interaction with the computing device 1100, including physical or virtual control buttons or keys, a microphone, a speaker, a unidirectional or bidirectional still and/or video camera, and/or others. The user interface subsystem 1130 may also include devices, such as motion sensors, proximity sensors, and eye tracking devices, which may be configured to detect, capture, and process various other forms of human interactions involving the computing device 1100.

The computing device 1100 further includes a communication subsystem 1132, which may be embodied as any communication circuit, device, or collection thereof, capable of enabling communications between the computing device 1100 and other electronic devices. The communication subsystem 1132 may be configured to use any one or more communication technology (e.g., wireless or wired communications) and associated protocols (e.g., Ethernet, Bluetooth™, Wi-Fi™, WiMAX, 3G/LTE, etc.) to effect such communication. The communication subsystem 1132 may be embodied as a network adapter, including a wireless network adapter.

The example computing device 1100 also includes a number of computer program components, such as the user space application 1134 and the privileged system component 1142. The user space application 1134 may be embodied as any computer application (e.g., software, firmware, hardware, or a combination thereof) that interacts directly or indirectly with an end user via, for example, the display device 1128 or the UI subsystem 1130. Some examples of user space applications 1134 include word processing programs, document viewers/readers, web browsers, electronic mail programs, messaging services, computer games, camera and video applications, etc. Among other things, the privileged system component 1142 facilitates the communication between the user space applications 1134 and the hardware components of the computing device 1100. Portions of the privileged system component 1142 may be embodied as any operating system capable of performing the functions described herein, such as a version of WINDOWS by Microsoft Corporation, ANDROID by Google, Inc., and/or others. Alternatively or in addition, a portion of the privileged system component 1142 may be embodied as any type of virtual machine monitor capable of performing the functions described herein (e.g., a type I or type II hypervisor).

The example privileged system component 1142 includes a number of computer program components, such as the memory manager module 1144 and the key creation module 1148. Each of the components of the privileged system component 1142 may be embodied as software, firmware, hardware, or a combination of software and hardware. For example, the components of the privileged system component 1142 may be embodied as modules of an operating system kernel, a virtual machine monitor, or a hypervisor. The memory manager module 1144 allocates portions of memory 1122 to the various processes running on the computing device 1100 (e.g., as ranges of virtual memory addresses). The memory manager module 1144 is embodied as, for example, a loader, a memory manager service, or a heap management service. The key creation module 1148 creates the secret keys 1116(1)-1116(N) (e.g., secret address keys and secret data keys) and writes them to a register or registers to which the processor 1102 has read access (e.g., a special purpose register). To create a secret key, the key creation module 1148 may execute, for example, a random number generator or another algorithm capable of generating a secret key that can perform the functions described herein.

It should be noted that a myriad of approaches could be used to generate or obtain a key for examples disclosed herein. For example, although the key creation module 1148 is shown as being part of computing device 1100, one or more secret keys could be obtained from any suitable external source using any suitable authentication processes to securely communicate the key to computing device 1100, which may include generating the key as part of those processes. Furthermore, privileged system component 1142 may be part of a trusted execution environment (TEE), virtual machine, processor 1102, a co-processor (not shown), or any other suitable hardware, firmware, or software in computing device 1100 or securely connected to computing device 1100. Moreover, the key may be “secret”, which is intended to mean that its value is kept hidden, inaccessible, obfuscated, or otherwise secured from unauthorized actors (e.g., software, firmware, machines, extraneous hardware components, and humans).

More details and aspects of the apparatus, device, computer system and method are mentioned in connection with the proposed concept, or one or more examples described above (e.g. FIGS. 1 to 8) or below. The apparatus, device, computer system and method may comprise one or more additional optional features corresponding to one or more aspects of the proposed concept, or one or more examples described above or below.

In the following, some examples of the proposed concept are presented:

An example (e.g., example 1) relates to an apparatus comprising memory circuitry, machine-readable instructions, and processor circuitry to execute the machine-readable instructions to obtain a hash value being indicative of an object path of an object, determine a specialization information being indicative of a location of a field of the object relative to the object, combine the hash value and the specialization information, and generate a cryptographic address of the field of the object, with the cryptographic address comprising the combination.

Another example (e.g., example 2) relates to a previous example (e.g., example 1) or to any other example, further comprising that the processor circuitry is to execute the machine-readable instructions to obtain the hash value being indicative of the object path of the object by decoding a cryptographic address of the object.

Another example (e.g., example 3) relates to a previous example (e.g., one of the examples 1 or 2) or to any other example, further comprising that the specialization information comprises an address displacement value of the field being indicative of the location of the field of the object relative to the object.

Another example (e.g., example 4) relates to a previous example (e.g., one of the examples 1 or 2) or to any other example, further comprising that the specialization information comprises a sequential field index being indicative of the location of the field of the object relative to the object.

Another example (e.g., example 5) relates to a previous example (e.g., one of the examples 1 to 4) or to any other example, further comprising that the combination comprises a second hash value being indicative of the object path of the object and the location of the field of the object relative to the object.

Another example (e.g., example 6) relates to a previous example (e.g., one of the examples 1 to 5) or to any other example, further comprising that the object path is a hierarchical object path comprising one or more levels of hierarchy.

Another example (e.g., example 7) relates to a previous example (e.g., one of the examples 1 to 6) or to any other example, further comprising that the processor circuitry is to execute the machine-readable instructions to include type information indicating a type or enumeration of the object or of the field in the cryptographic address of the field of the object.

Another example (e.g., example 8) relates to a previous example (e.g., example 7) or to any other example, further comprising that the processor circuitry is to execute the machine-readable instructions to combine the hash value, the specialization information and the type information, with the cryptographic address of the field of the object comprising the combination.

Another example (e.g., example 9) relates to a previous example (e.g., one of the examples 7 or 8) or to any other example, further comprising that the processor circuitry is to execute the machine-readable instructions to generate metadata associated with the cryptographic address, and include at least a subset of the type information in the metadata.

Another example (e.g., example 10) relates to a previous example (e.g., example 9) or to any other example, further comprising that the type information stored in the metadata is to be retrieved during decryption or specialization of the cryptographic address of the field of the object.

Another example (e.g., example 11) relates to a previous example (e.g., one of the examples 9 to 10) or to any other example, further comprising that the metadata is linked to the cryptographic address.

Another example (e.g., example 12) relates to a previous example (e.g., one of the examples 9 to 11) or to any other example, further comprising that the type information is stored in the metadata for binary compatibility with other systems or legacy instructions.

Another example (e.g., example 13) relates to a previous example (e.g., one of the examples 1 to 12) or to any other example, further comprising that generating the cryptographic address comprises encrypting the combination as part of encrypting the cryptographic address.

Another example (e.g., example 14) relates to a previous example (e.g., one of the examples 1 to 13) or to any other example, further comprising that generating the cryptographic address of the field of the object is performed at runtime based on the cryptographic address of the object, the cryptographic address of the object comprising the hash value being indicative of an object path of an object.

Another example (e.g., example 15) relates to a previous example (e.g., one of the examples 1 to 14) or to any other example, further comprising that the cryptographic address of the field of the object is a pointer to the field of the object.

Another example (e.g., example 16) relates to a previous example (e.g., one of the examples 1 to 15) or to any other example, further comprising that the cryptographic address of the field of the object and/or a cryptographic address of the object is an encrypted memory address.

Another example (e.g., example 17) relates to a previous example (e.g., one of the examples 1 to 16) or to any other example, further comprising that the cryptographic address of the field of the object and/or a cryptographic address of the object is an encrypted memory address according to Cryptographic Capability Computing.

An example (e.g., example 18) relates to an apparatus comprising processor circuitry configured to obtain a hash value being indicative of an object path of an object, determine a specialization information being indicative of a location of a field of the object relative to the object, combine the hash value and the specialization information, and generate a cryptographic address of the field of the object, with the cryptographic address comprising the combination.

An example (e.g., example 19) relates to a device comprising means for processing for obtaining a hash value being indicative of an object path of an object, determining a specialization information being indicative of a location of a field of the object relative to the object, combining the hash value and the specialization information, and generating a cryptographic address of the field of the object, with the cryptographic address comprising the combination.

An example (e.g., example 20) relates to a method comprising obtaining a hash value being indicative of an object path of an object, determining a specialization information being indicative of a location of a field of the object relative to the object, combining the hash value and the specialization information, and generating a cryptographic address of the field of the object, with the cryptographic address comprising the combination.

Another example (e.g., example 21) relates to a computer system comprising the apparatus or device according to one of the examples 1 to 19.

Another example (e.g., example 22) relates to a computer system being configured to perform the method of example 20 or 27.

Another example (e.g., example 23) relates to a non-transitory, computer-readable medium comprising a program code that, when the program code is executed on a processor, a computer, or a programmable hardware component, causes the processor, computer, or programmable hardware component to perform the method of example 20 or 27.

Another example (e.g., example 24) relates to a non-transitory machine-readable storage medium including program code, when executed, to cause a machine to perform the method of example 20 or 27.

Another example (e.g., example 25) relates to a computer program having a program code for performing the method of example 20 or 27 when the computer program is executed on a computer, a processor, or a programmable hardware component.

Another example (e.g., example 26) relates to a machine-readable storage including machine readable instructions, when executed, to implement a method or realize an apparatus as in any example.

Another example (e.g., example 27) relates to a method comprising obtaining a hash value being indicative of an object path of an object; obtaining type information indicating a type or enumeration of the object or of the field of the object; combining the hash value and the type information; and generating a cryptographic address of the field of the object, with the cryptographic address comprising the combination. The type information or type ID can be any numerical value that represents some type or property the compiler is aware of (e.g., it could be based on structure name, element types, array size, or possibly attributes such as ‘const’). The type information or type ID may be based on the object primitive type (e.g., char or int), element types or structure of compound types (e.g., of arrays or structs), or other attributes (e.g., whether the pointed-to object/field is a constant).

Another example (e.g., example 28) relates to a non-transitory, computer-readable medium comprising a program code that, when the program code is executed on a processor, a computer, or a programmable hard-ware component, causes the processor, computer, or programmable hardware component to obtain an initial hash value of an object path of an object; obtain specialization information being indicative of a location of a field of the object relative to a reference location of the object; calculating a subsequent hash value based on the initial hash value and the specialization information; and generate a cryptographic address of the field of the object based on the subsequent hash value.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising memory circuitry, machine-readable instructions, and processor circuitry to execute the machine-readable instructions to:
obtain a hash value being indicative of an object path of an object;
obtain specialization information being indicative of a location of a field of the object relative to the object;
combine the hash value and the specialization information; and
generate a cryptographic address of the field of the object, with the cryptographic address comprising the combination.

2. The apparatus according to claim 1, wherein the processor circuitry is to execute the machine-readable instructions to obtain the hash value being indicative of the object path of the object by decoding a cryptographic address of the object.

3. The apparatus according to claim 1, wherein the specialization information comprises an address displacement value of the field being indicative of the location of the field of the object relative to the object.

4. The apparatus according to claim 1, wherein the specialization information comprises a sequential field index being indicative of the location of the field of the object relative to the object.

5. The apparatus according to claim 1, wherein the combination comprises a second hash value being indicative of the object path of the object and the location of the field of the object relative to the object.

6. The apparatus according to claim 1, wherein the object path is a hierarchical object path comprising one or more levels of hierarchy.

7. The apparatus according to claim 1, wherein the processor circuitry is to execute the machine-readable instructions to include type information indicating a type of the field in the cryptographic address of the field of the object.

8. The apparatus according to claim 7, wherein the processor circuitry is to execute the machine-readable instructions to combine the hash value, the specialization information and the type information, with the cryptographic address of the field of the object comprising the combination.

9. The apparatus according to claim 7, wherein the processor circuitry is to execute the machine-readable instructions to generate metadata associated with the cryptographic address, and include at least a subset of the type information in the metadata.

10. The apparatus according to claim 9, wherein the type information stored in the metadata is to be retrieved during decryption or specialization of the cryptographic address of the field of the object.

11. The apparatus according to claim 9, wherein the metadata is linked to the cryptographic address.

12. The apparatus according to claim 9, wherein the type information is stored in the metadata for binary compatibility with other systems or legacy instructions.

13. The apparatus according to claim 1, wherein generating the cryptographic address comprises encrypting the combination as part of encrypting the cryptographic address.

14. The apparatus according to claim 1, wherein generating the cryptographic address of the field of the object is performed at runtime based on the cryptographic address of the object, the cryptographic address of the object comprising the hash value being indicative of an object path of an object.

15. The apparatus according to claim 1, wherein the cryptographic address of the field of the object is a pointer to the field of the object.

16. The apparatus according to claim 1, wherein the cryptographic address of the field of the object and/or a cryptographic address of the object is an encrypted memory address.

17. The apparatus according to claim 1, wherein the cryptographic address of the field of the object and/or a cryptographic address of the object is an encrypted memory address according to Cryptographic Capability Computing.

18. A method comprising:
obtaining a hash value being indicative of an object path of an object;
obtaining type information indicating a type or enumeration of the field of the object;
combining the hash value and the type information; and
generating a cryptographic address of the field of the object, with the cryptographic address comprising the combination.

19. A non-transitory, computer-readable medium comprising a program code that, when the program code is executed on a processor, a computer, or a programmable hardware component, causes the processor, computer, or programmable hardware component to:
obtain an initial hash value of an object path of an object;
obtain specialization information being indicative of a location of a field of the object relative to a reference location of the object;
calculating a subsequent hash value based on the initial hash value and the specialization information; and
generate a cryptographic address of the field of the object based on the subsequent hash value.
